(19) United States
(12) Patent Application Publication
(10) Pub. No.: US 2015/0170221 A1
(43) Pub. Date: Jun. 18, 2015

(54) AUDIENCE SEGMENT ANALYSIS

(71) Applicant: Turn Inc., Redwood City, CA (US)

(72) Inventor: Neil Shah, San Francisco, CA (US)

(73) Assignee: Turn Inc., Redwood City, CA (US)

(21) Appl. No.: 14/132,293

(22) Filed: Dec. 18, 2013

(51) Int. Cl. G06Q 30/02

(52) U.S. Cl. CPC G06Q 30/0275

(57) ABSTRACT

Techniques and mechanisms described herein facilitate audience segment analysis. According to various embodiments, a performance metric for an initial audience segment may be identified. The initial audience segment may designate a first criterion used to select a first plurality of advertising opportunity bid requests for bid placement. An updated audience segment may be determined based on the performance metric. The updated audience segment may designate a second criterion used to select a second plurality of advertising opportunity bid requests for bid placement. A message to place a bid for an advertising campaign on an advertising opportunity bid request may be transmitted. The advertising opportunity bid request may be associated with an advertising audience member matching the second criterion.

### TECHNICAL FIELD

The present disclosure relates generally to audience segment analysis and more specifically to the efficient selection of audience segments for online advertising campaigns.

### DESCRIPTION OF RELATED ART

In online advertising, internet users are presented with advertisements as they browse the internet using a web browser. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible given one or more budget restrictions. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

Advertisers may prefer to target a particular group of end users when presenting an advertisement as part of an advertising campaign. Advertisers may be faced with a very large number of options when selecting between different groups of end users. Providing advertisements to different groups of end users may be associated with different advertising costs and provide different rates of return to advertisers.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide mechanisms for audience segment analysis. According to various embodiments, a performance metric for an initial audience segment may be identified. The initial audience segment may designate a first criterion used to select a first plurality of advertising opportunity bid requests for bid placement. An updated audience segment may be determined based on the performance metric. The updated audience segment may designate a second criterion used to select a second plurality of advertising opportunity bid requests for bid placement. A message to place a bid for an advertising campaign on an advertising opportunity bid request may be transmitted. The advertising opportunity bid request may be associated with an advertising audience member matching the second criterion.

According to various embodiments, determining the updated audience segment may include determining a respective performance metric for each of a plurality of subsets of the initial audience segment. A first one of the subsets may be designated for inclusion in the updated audience segment via the computer processor when it is determined that the first one of the subsets is associated with a respective performance metric that exceeds a designated performance metric threshold value.

According to various embodiments, determining the updated audience segment may include identifying a first ordering of a plurality of subsets of the initial audience segment and/or determining a second ordering of the plurality of subsets for inclusion in the updated audience segment. The second ordering may be different than the first ordering. Each of the first and second orderings may prioritize advertising opportunity bid requests that correspond to earlier-ordered subsets. Each of the first and second orderings may designate a respective order in which the plurality of subsets are joined by a Boolean OR operator.

According to various embodiments, determining the updated audience segment may include determining a second audience segment portion for inclusion in the updated audience segment based on a first audience segment portion included in the initial audience segment. The second audience segment portion may include the first audience segment portion. The second audience segment portion may be broader than the first audience segment portion. The second criterion may include the first criterion and a third criterion joined by a Boolean OR operator.

In particular embodiments, determining determine the updated audience segment may include determining a second audience segment portion for inclusion in the updated audience segment based on a first audience segment portion included in the initial audience segment. The first audience segment portion may include the second audience segment portion. The first audience segment portion may be broader than the second audience segment portion.

According to various embodiments, the first audience segment portion may include a first criterion for selecting advertising opportunity bid requests for bid placement. The second audience segment portion may include the first criterion and a second criterion for selecting advertising opportunity bid requests for bid placement. The first and second criteria may be joined by a Boolean AND operator.

In particular embodiments, the performance metric may be a metric such as cost-per-click (CPC), cost-per-action (CPA), click-through-rate (CTR), or action-rate (AR).

According to various embodiments, identifying a performance metric for the initial audience segment may include identifying a first subset of the plurality of advertising opportunity bid requests selected for bid placement that resulted in placed advertisements, determining a respective outcome measure for each of the bids within the first subset, and/or aggregating the respective outcome measures.

According to various embodiments, each of the first and second pluralities of advertising opportunity bid requests may be received from a real-time bid exchange operable to facilitate the programmatic buying and selling of advertising impressions via a network. Each of the initial audience segment and the updated audience segment may designate a respective one or more data sources. Each data source may identify a respective group of individuals having one or more characteristics in common.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates an example of an audience segment determination method, performed in accordance with one or more embodiments.

FIG. 2 illustrates an example of an audience segment data hierarchy graph, presented in accordance with one or more embodiments.

FIG. 3 illustrates an example of a subset ranking audience segment determination method, performed in accordance with one or more embodiments.

FIG. 4 illustrates an example of an audience segment expansion method, performed in accordance with one or more embodiments.

FIG. 5 illustrates an example of an audience segment restriction method, performed in accordance with one or more embodiments.

FIG. 6 illustrates an example of an order rotation audience segment determination method, performed in accordance with one or more embodiments.

FIG. 7 illustrates an example of a server, configured in accordance with one or more embodiments.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular techniques and mechanisms related to advertising campaigns. However, it should be noted that the techniques and mechanisms of the present invention apply to a variety of different computing techniques and mechanisms. In the following description, numerous specific details are set forth in order to provide a thorough understanding of the present invention. Particular example embodiments of the present invention may be implemented without some or all of these specific details. In other instances, well known process operations have not been described in detail so as not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

According to various embodiments, techniques and mechanisms described herein facilitate audience segment analysis. When executing an online advertising campaign, an advertiser or an agent of an advertiser spends an advertising budget by bidding on advertising requests provided by a real time bidding (RTB) exchange. An advertising campaigns managed by a demand-side platform (DSP) may be configured to target any of many different arrangements of audience segments. For instance, audience segments may be configured based on properties such as the age, sex, income, geographic location of its members. The selection of different audience segments may be associated with different costs and benefits. The costs and benefits associated with different audience segment arrangements may be analyzed to produce a high performance audience segment. This high performance audience segment may be used to select advertising opportunity bid requests for bid placement in such a way that a high ratio of advertising opportunity quality to cost may be achieved.

### Example Embodiments

In recent years, the amount of ad impressions sold through real time bidding (RTB) exchanges has experienced a tremendous growth. RTB exchanges provide a technology for advertisers to algorithmically place a bid on any individual impression through a public auction. This functionality allows advertisers to buy inventory in a cost effective manner and to serve ads to the right person in the right context at the right time. However, in order to realize such functionality, advertisers need to intelligently evaluate each impression in real time or near real time. Demand-side platforms (DSPs) provide real time bid optimization techniques to help advertisers determine a bid value for each ad request very quickly. For instance, a DSP may determine a bid value in milliseconds for close to a million bids per second.

In order to use the services of a DSP, an advertiser may specify one or more parameters for an advertising campaign. The advertising campaign may include features such as a target audience, one or more budget restrictions, and one or more desired performance metric goals. In some instances, the DSP may assist the advertiser in configuring the advertising campaign. According to various embodiments, the advertiser may designate an initial target audience, and the advertising system may recommend modifications to the initial target audience to provide improved advertising campaign performance.

In some implementations, a target audience for an advertising campaign may be selected by designating one or more data sources and/or data categories. Each data source may be provided by a data service provider. The data service provider may provide data for determining whether a potential advertising audience member associated with an incoming advertising opportunity bid request falls within a designated category.

For example, a data service provider may provide a data source that distinguishes between many advertising opportunity bid requests based on geographic region within the United States. Categories within this data source may include states, major cities, zipcodes, and direct marketing areas (DMAs) within the United States.

As another example, a data service provider may provide a data source that distinguishes between many advertising opportunity bid requests based on estimated yearly income. Categories within this data source may include income ranges such as “$15,000-$30,000” and “$30,000-$45,000”.

According to various embodiments, data categories may distinguish between potential advertising audience members based on any of potentially many different factors. These factors may include, but are not limited to: age, sex, race, income, purchasing patterns, purchasing intent, personal interests, education, profession, consumer preferences, political affiliations, and geographic region.

According to various embodiments, different data sources and/or categories may be linked together, for instance via Boolean logic. Boolean logic may include operators such as “AND” and “OR”. Data categories that are linked together may form a data segment that can be used to select advertising opportunity bid requests for bid placement. For instance, one data segment is labeled Segment 1, composed of data categories A, B, C, and D, and formulated according to the following equation.

Segment 1=A OR B OR (C AND D)

In this example, the data category A may represent one audience segment subset such as “males aged 30-45” while the data category B may represent a different audience subset such as “females aged 28-40”. The data categories C and D may represent other audience subsets such as “ages 18-30” and “an income of more than $80,000 per year”.

According to various embodiments, a data segment may be used to select incoming advertising opportunity bid requests for bid placement. For instance, an advertising opportunity bid request may be associated with an individual identified as likely being female and 32 years of age. Such an ad request would not fall into the data category A or in the combined category (C AND D) but would fall into the category B in the above example.

In particular embodiments, the ordering of the categories within a data segment may influence bid placement. For instance, an advertising campaign may be allotted a designated budget to spend within a given time period. If more advertising opportunity bid requests that match the criteria specified by the data segment are received during the time period than would be possible to purchase using the designated budget, then some data categories may be prioritized over other data categories. For instance, one possible order priority may prioritize category A first, category B second, and the combined category (C AND D) third in the above example based on the order in which they are listed. However, other prioritization schemes are possible. In some instances, a data category that is assigned a relatively low priority within a data segment may potentially have no effect on the bids placed or the advertising opportunities purchased, such as when the entire budget for the period is spent first on advertising opportunities associated with other data categories that have a higher priority.

According to various embodiments, the cost of advertising opportunities purchased for an advertising campaign may reflect both the cost of the data used to determine whether to bid on an advertising opportunity and the cost of purchasing the advertising opportunity if the bid is successful.

In particular embodiments, the use of different data sources and/or data categories may involve different costs. These costs may be paid to the provider of the data. For instance, the use of one data category such as category A in the preceding example may require a payment of $2.00 per thousand impressions, while the use of a different data source such as category B may require a payment of $1.50 per thousand impressions.

However, in many instances cost alone may be an insufficient criterion for advertisers wishing to choose between different data categories and/or data sources. For example, data from one category and/or source may be of higher quality than data from a different category and/or source. Thus, measuring the value of a data source may involve considering both the cost and the benefit of the data source. As another example, data from one category and/or source may be more relevant for a particular advertising campaign than data from a different category and/or source. Thus, different advertising campaigns may receive different value from the same advertising source.

According to various embodiments, the cost of data may be attributed in any of various ways. For instance, if an advertising opportunity corresponds to both of different categories joined by an “AND” operator, then the cost of the advertising opportunity may be shared between the categories. If instead an advertising opportunity corresponds to both of two or more different categories joined by an “OR” operator, then the cost of the advertising opportunity may be assigned to the higher priority category or may be shared between the categories.

Performance of real time bid optimization in a RTB environment can be challenging for any or all of various reasons. Determining which market segment to target in order to achieve cost-effective results for an advertising campaign may be difficult. In advertising systems with many different data categories available for selection when forming a data segment, the number of possible combinations of categories may be very large. Manually identifying a particularly successful, high value combination of categories may then involve running potentially many different reports to compare data performance with advertising campaign performance metric goals.

According to various embodiments, techniques and mechanisms described herein may be used to dynamically determine a high value data segment for an advertising campaign. For instance, a data segment that provides a desired performance metric outcome measured in terms of terms of cost-per-click (CPC), cost-per-action (CPA), click-through-rate (CTR), action-rate (AR), and/or other performance metric variable may be identified.

In an RTB environment, the decision as to whether to place a bid and how to evaluate the bid price may need to be performed for an individual ad request very quickly, for instance in only a few milliseconds. At the same time, some DSPs typically receive as many as a million ad requests per second while hundreds of millions of users simultaneously explore the web around the globe. The short latency and high throughput requirements can introduce extreme time sensitivity into the process. In addition, click and conversion events can be very rare for non-search advertisement. Therefore, the variance when estimating past performance metrics can be large. Techniques described herein may be used to address one or more of these types of issues.

In some implementations, techniques and mechanisms may be described herein as solving “optimization” problems or as “optimizing” one or more parameters. It should be noted that the term optimize does not imply that the solution determined or parameter selected is necessarily the best according to any particular metric. For instance, some optimization problems are computationally intense, and computing the best solution may be impractical. Accordingly, optimization may involve the selection of a suitable parameter value or a suitably accurate solution. In some instances, the suitability of a parameter value or solution may be strategically determined based on various factors such as one or more computing capabilities, problem characteristics, and/or time constraints.

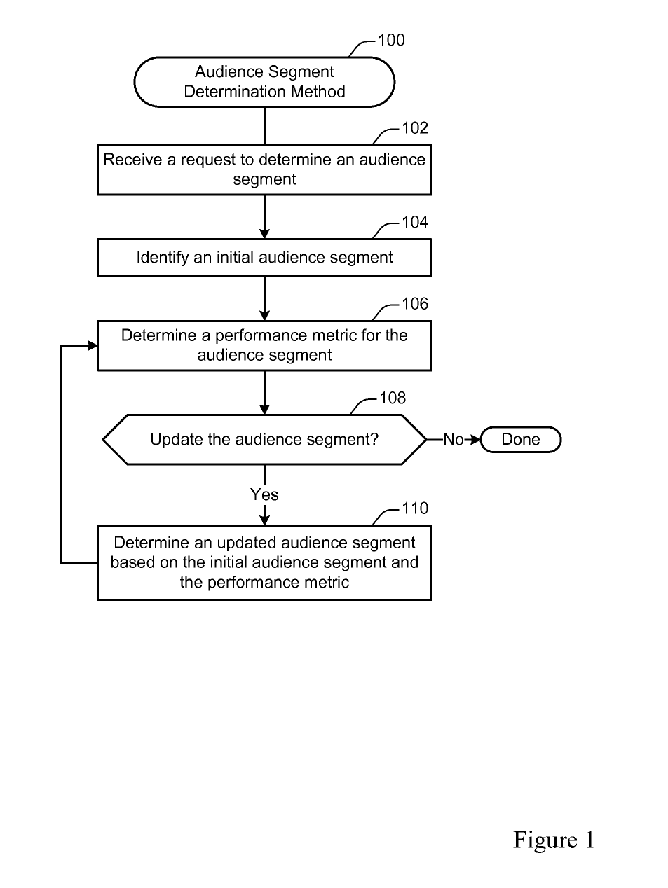

FIG. 1 illustrates an example of an audience segment determination method 100, performed in accordance with one or more embodiments. According to various embodiments, the method 100 may be performed at a computing system configured to provide advertising campaign management services. For instance, the system may be configured to establish parameters for different advertising campaigns, to receive advertising opportunity bid requests from a real time bid exchange system via a network, to place bids on at least some of the received bid requests, and to evaluate the performance of the advertising campaigns.

At 102, a request to determine an audience segment is determined. In some implementations, the request may be generated when a new advertising campaign is configured or when an existing advertising campaign is designated for reconfiguration. The request may be generated manually by a user such as an advertiser or system administrator. Alternately, or additionally, the request may be generated automatically by the advertisement campaign management system.

At 104, an initial audience segment is identified. According to various embodiments, the initial audience segment may be identified in any of various ways. For instance, an advertiser who requests and configures an advertising campaign may specify an initial audience segment. For example, an advertising campaign for a car designed for younger people may include an initial audience segment of 16-24 year old individuals who make less than $40,000 per year. As another example, an advertising campaign for luxury jewelry may target high income individuals within a designated geographic region.

The initial audience segment may also be identified at least in part based on automatic analysis. For instance, an advertiser may provide some number of initial parameters. The advertisement system may then use these parameters to recommend an initial audience segment to the advertiser, who may accept or adjust the initial audience segment before it is applied.

At 106, a performance metric is determined for the audience segment. According to various embodiments, different types of performance metrics may be used to evaluate the success of a strategy that targets a designated audience segment. For instance, in an advertising campaign, a performance metric may be measured in terms of cost-per-click (CPC), cost-per-action (CPA), click-through-rate (CTR), action-rate (AR), or some combination thereof. In general, a lower CPC or CPA is more desirable, while a higher CTR or AR is more desirable.

In particular embodiments, the performance of an audience segment may be influenced by the cost of data associated with advertising opportunities purchased based on the audience segment. For example, an advertising campaign for which a budget of $100,000 is allocated may involve paying $75,000 for advertisements and $25,000 for data used to identify the advertisements to buy. If less money is spent buying the data, then more money can be used to buy advertisements for the same budget. Some audience segments may be more expensive than other audience segments due to the cost of the data associated with the categories used to configure an audience segment. Thus, the performance metric of the audience segment may take the cost of data and/or other costs into account.

Alternately, cost may not be an issue when determining a performance metric. For instance, some advertisers may prioritize brand lift and may not choose to prioritize audience segments based on cost.

According to various embodiments, the performance metric may be determined by identifying performance data for past advertising campaign opportunity purchases. For instance, some number of advertising opportunity bid requests may be received by the advertising system during a designated time period. The advertising system may determine whether a received bid request is associated with an individual who is a member of the initial audience segment identified in operation 104 or an updated audience segment identified in operation 110. One or more of the bid requests associated with individuals who members of the audience segment may be selected for placing bids in an auction format. Depending on the bid price and the placement of any competing bids, one or more of the placed bids may be successful.

In some implementations, the advertising system may receive and/or determine performance metric information for the successful bids. For instance, an average CPC, CPA, CTR, or AR may be determined for the successful bids. In this way, the performance of an audience segment may be evaluated and compared to the performance of other audience segments to determine which audience segment is more successful in meeting the goals of the advertising campaign.

In some embodiments, the advertising system may determine a performance metric for the audience segment as a whole. Alternately, or additionally, the audience segment may be at least partially disaggregated, and different performance metrics may be determined for different subsets of the audience segment. For instance, if an audience segment includes females aged 22-35 who have a yearly salary of $40,000-$75,000, then a performance metric may be determined for the entire audience segment and/or for particular subsets of the audience segment. For example, one subset may be females aged 22-26 who have a yearly salary of $40,000-$55,000.

At 108, a determination is made as to whether to update the audience segment. According to various embodiments, the determination as to whether to update the audience segment may be based on any of various considerations. For example, an advertising campaign may be associated with a performance threshold. In this case, when the performance threshold is not met, the audience segment may be updated in an effort to improve performance.

As another example, an advertising campaign may be automatically or manually placed in a configuration mode for a designated period of time or to achieve a designated performance metric goal. In this case, the audience segment may continue to be updated until the period of time has elapsed or the performance metric goal has been achieved.

As yet another example, an audience segment may continue to be updated so long as increases in one or more performance metrics are being realized. For instance, a performance metric may indicate a target level for a metric or may indicate that the metric is to be maximized or minimized, whichever is appropriate. In this case of maximization or minimization, the audience segment may continue to be updated so long as successive updates to the audience segment yield significant performance gains.

In particular embodiments, the performance of successive audience segments may be stored, for instance in a storage system associated with the advertising campaign service provider. Then, the performance of successive audience segments may be tracked over time. For instance, a variety of different audience segments may be tested during a testing period. Then, a high performing audience segment may be selected for use during a performance period.

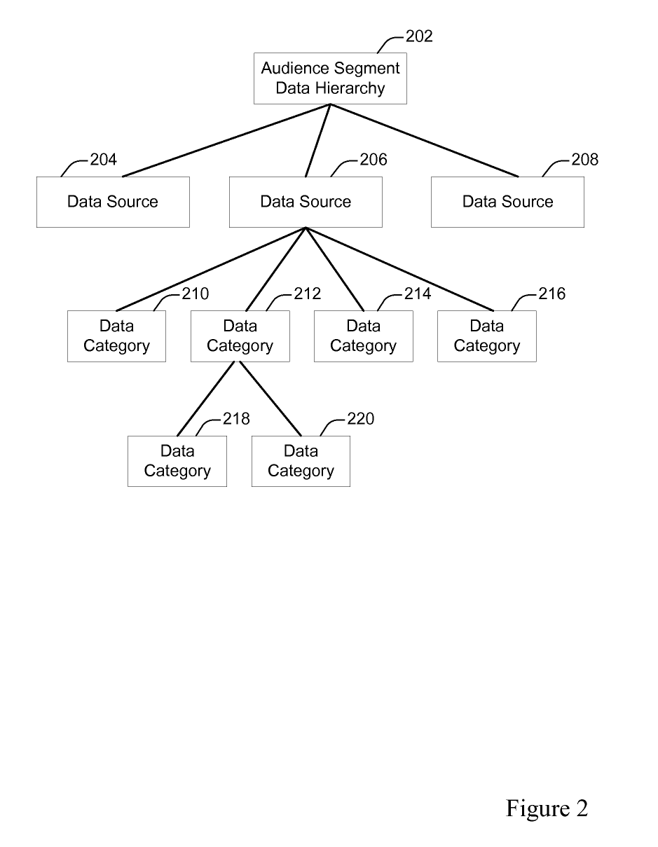

At 110, an updated audience segment is determined. According to various embodiments, an updated audience segment may be determined by using any of various techniques, which may include but are not limited to the techniques discussed with respect to the methods shown in FIGS. 2-6.

For example, one or more subsets of the audience segment may be identified as high performing. In this case, relatively high performing subsets may be selected for inclusion in an updated audience segment, while relatively lower performing subsets may be omitted. Examples of techniques for subset ranking audience segment determination are discussed with respect to the method 200 shown in FIG. 2.

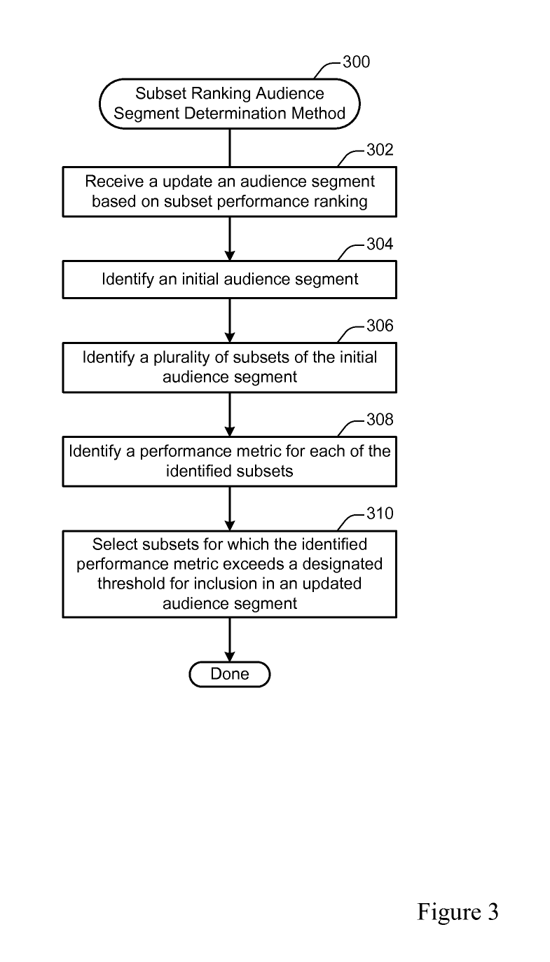

As another example, an audience segment may be expanded to include a broader audience by using less restrictive audience parameters. Examples of techniques for audience expansion are discussed with respect to the method 300 shown in FIG. 3.

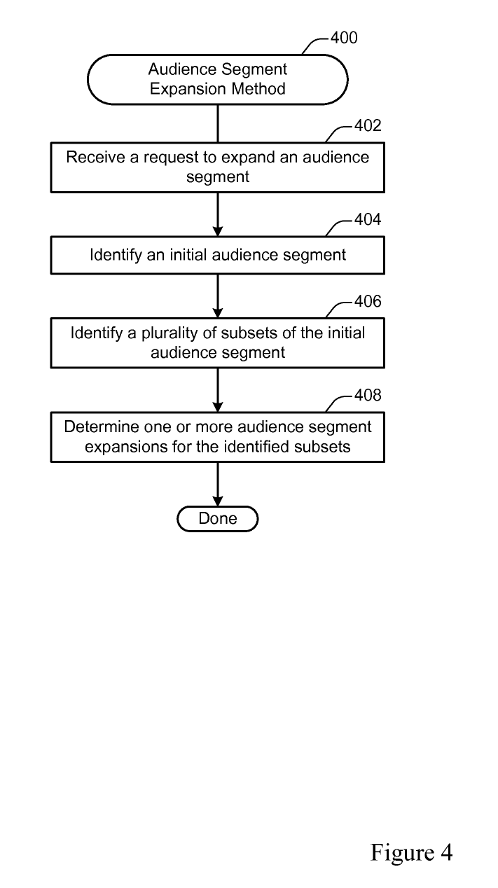

As yet another example, an audience segment may be restricted to include a more narrow audience by using more restrictive audience parameters. Examples of techniques for audience restriction are discussed with respect to the method 400 shown in FIG. 4.

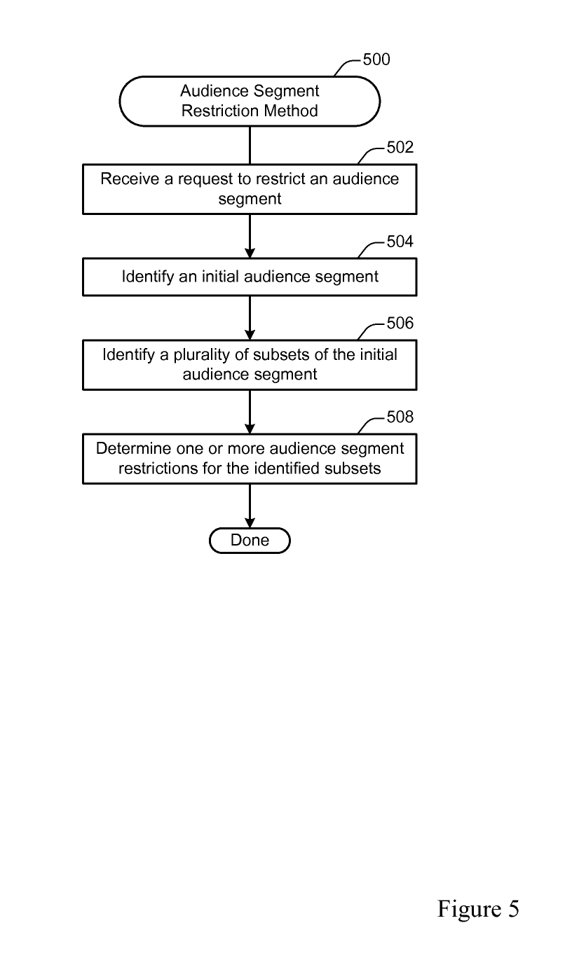

As still another example, different portions of an audience described by a set of audience parameters may be prioritized for selection when a surplus of available opportunities is received. Such techniques may be referred to herein as audience rotation or audience order rotation. Examples of techniques for audience order rotation are discussed with respect to the method 500 shown in FIG. 5.

FIG. 2 illustrates an example of an audience segment data hierarchy graph, presented in accordance with one or more embodiments. The hierarchy graph shown in FIG. 2 represents a portion of the data categories and sources available that may be available for selection to include in an audience segment. The hierarchy graph includes the audience segment data hierarchy 202, the data sources 204-208, and the data categories 210-220.

According to various embodiments, the audience segment data hierarchy 202 may include any number of data sources and data categories for selection. As discussed herein, data categories and sources may be selected by an advertiser, by an advertising campaign service provider, or by different parties working together.

According to various embodiments, the data sources 204-208 each represent a source of data for classifying or categorizing advertising opportunity bid requests. For example, different data sources may correspond to different data vendors and/or different datasets.

According to various embodiments, the data categories 210-220 each represent a class, property, type, or category that may be associated with an advertising opportunity bid request. For example, the data categories 214 and 216 may represent males and females respectively. As another example, the data category 212 may represent income, while the subcategories 218 and 220 may represent different income ranges. As discussed herein, different categories from the same data source or from different data sources may be combined to compose an audience segment for use in selecting advertising opportunity bid requests for bid placement.

FIG. 3 illustrates an example of a subset ranking audience segment determination method 300, performed in accordance with one or more embodiments. According to various embodiments, the method 300 may be performed in order to identify one or more subsets of an audience segment that are associated with higher performance than other portions of the audience segment. The relatively higher performance subsets may then be selected for inclusion in an updated audience segment for usage in a subsequent period of the advertising campaign.

At 302, a request to update an audience segment based on performance ranking is received. In some embodiments, the request may be generated as part of a configuration process for an advertising campaign, as discussed with respect to FIG. 1. For instance, the request may be generated when a determination is made to update an audience segment, as discussed with respect to operation 110 shown in FIG. 1.

At 304, an initial audience segment is identified. As discussed with respect to operation 104 shown in FIG. 1, the initial audience segment may be a set of parameters identifying individuals who may be identified for advertising opportunity bid placement by an advertising system. The initial audience segment may be any audience segment associated with the advertising campaign for which performance metric information is available. For instance, the initial audience segment may be any audience segment that is associated for which bids associated with the advertising campaign have previously been placed.

At 306, a plurality of subsets of the initial audience segment is identified. In some embodiments, subsets may be identified based on data sources available for data service providers. For instance, a data service provider may include a data source that identifies age ranges such as 16-20, 21-25, 26-30, and so on. A data service provider may also divide yearly income into ranges such as $30,000-$50,000, $50,000-$75,000, and so on.

In some implementations, an audience segment may correspond to a single identifier, such as the age range 21-25. Alternately, or additionally, an audience segment may correspond to a combination of identifiers, such as males aged 21-25 with an estimated yearly income of $30,000-$50,000. Various considerations may be used to determine the audience segments to identify for analysis.

For example, a sufficient quantity of data associated with an audience subset may be needed in order to reliably evaluate the performance of the audience subset. Thus, increased granularity of audience subsets may be used when relatively more performance data is available. In contrast, when relatively less performance data is available then audience subsets may be selected with decreased granularity.

As another example, different types of advertising campaigns may benefit differently from different types of analysis. For instance, a more focused advertising campaign may benefit from more granular analysis of the audience segment. In contrast, a more general advertising campaign may benefit from a coarser audience segment analysis.

As yet another example, the audience segments identified for analysis may be selected at least in part based on parameters specified by a user such as an advertiser or system administrator. For instance, a user may designate a particular variable such as age or income as important for analysis, and that variable may be selected for use in disaggregating an audience segment.

At 308, a performance metric is identified for each of the identified subsets. According to various embodiments, the identification of the performance metric may be performed in a manner similar to that discussed with respect to operation 106 shown in FIG. 1. The performance of successful bids placed for advertising opportunity bid requests associated with individuals within an audience segment may be aggregated into a combined performance metric for a subset of the audience segment. The performance metric may be measured using CPC, CPA, CTR, AR, or some combination thereof.

At 310, one or more of the identified subsets are selected for inclusion in an updated audience segment. According to various embodiments, a subset may be selected for inclusion based on whether a performance metric associated with the subset exceeds a designated threshold. For instance, the subsets may be ranked based on their respective performance metrics. Then, subsets may be selected for inclusion in the updated audience segment starting at the top of the rank-ordered list. In this way, the best-performing audience segment subsets may be selected for continued advertising campaign targeting, while the worst-performing audience segment subsets may be omitted from future targeting.

In particular embodiments, a subset may be selected for inclusion based on a desired size of the updated segment. For instance, an advertiser may seek to include a designated number of individuals, such as 250,000, in the audience segment targeted by the advertising campaign. In this case, a sufficient number of the best performing audience segment subsets may be selected so that the designated number of individuals is reached.

In particular embodiments, a subset may be selected for inclusion based on a target or designated performance metric threshold. For instance, an advertiser may indicate a designated CPC, CPA, CTR, or AR goal or minimum threshold for the advertising campaign. In this case, subsets that exceed the goal or minimum threshold may be selected for inclusion in an updated audience segment.

As discussed with respect to FIG. 1, the updated audience segment may be used for subsequent decisions when placing bids in advertising opportunity bid requests. Then, performance data associated with the updated audience segment may be collected and used to analyze the performance of the updated audience segment. The updated audience segment may then be treated as the initial audience segment, and the performance data may be used to generate a subsequent updated audience segment to further refine the targeting of the advertising campaign.

FIG. 4 illustrates an example of an audience segment expansion method 400, performed in accordance with one or more embodiments. The method 400 may be performed in order to build a more inclusive audience segment than the initial audience segment. For instance, if it is determined that the initial audience segment performs relatively well but that the number of audience members identified by the initial audience segment is comparatively small, and then the initial audience segment may be expanded via the audience segment expansion method.

At 402, a request to expand an audience segment is received. In some embodiments, the request may be generated as part of a configuration process for an advertising campaign, as discussed with respect to FIG. 1. For instance, the request may be generated when a determination is made to update an audience segment, as discussed with respect to operation 110 shown in FIG. 1.

At 404, an initial audience segment is identified. As discussed with respect to operation 104 shown in FIG. 1, the initial audience segment may be a set of parameters identifying individuals who may be identified for advertising opportunity bid placement by an advertising system. The initial audience segment may be any audience segment associated with the advertising campaign for which performance metric information is available. For instance, the initial audience segment may be any audience segment that is associated for which bids associated with the advertising campaign have previously been placed.

At 406, a plurality of subsets of the initial audience segment is identified. In some embodiments, the operation 406 may be substantially similar to the operation 206 discussed with respect to FIG. 2. Subsets may be identified based on various considerations such as the data sources available from data service providers, the amount of data available for a potential audience segment subset, the type of advertising campaign associated with the performance data being analyzed, and/or parameters specified by a user such as an advertiser or system administrator.

At 408, one or more audience segment expansions for the identified subsets are determined Various types of audience segment expansions may be determined. In some implementations, an audience segment expansion may be determined by broadening beyond the audience segment subsets in the initial audience segment by expanding a range, by broadening within a taxonomy or hierarchy, by randomly selecting additional categories for inclusion in the audience segment, or by any other technique for selecting a broader set of categories for inclusion in the audience segment.

In some implementations, an audience segment expansion may be determined by expanding a range. For example, an initial audience segment or initial audience segment portion may target individuals with an estimated yearly income of between $45,000-$55,000. Then, an audience segment expansion may target individuals with an estimated yearly income of between $35,000-$75,000. As another example, an initial audience segment or initial audience segment portion may target individuals aged 24-35. In this case, an audience segment expansion may target individuals aged 20-42.

In some implementations, an audience segment expansion may be determined by broadening a geographic region. For example, an initial audience segment or initial audience segment portion may target individuals within particular cities within a state. In this case, an audience segment expansion may target individuals anywhere within the state, or within a broader geographic region that includes the state.

In some implementations, an audience segment expansion may be determined by broadening by hierarchy or taxonomy name. For example an initial audience segment or segment portion may target females. In this case, an audience segment expansion may target both males and females. As another example, an initial audience segment or segment portion may target “In-market Honda Civic shoppers”. In this case, an audience segment expansion may target a broader segment such as “In-market Honda shoppers”, or “In-market auto shoppers”. As yet another example, an initial audience segment or segment portion may target “Travel Intent: Cancun”. In this case, an audience segment expansion may target a broader segment such as “Travel Intent: Caribbean” or “Holiday Travel Intent”.

In some implementations, an audience segment expansion may be determined by broadening randomly. For instance, additional categories may be selected at random for inclusion in the updated audience segment in order to potentially discover other high value audience segment portions that may not be apparent to an advertiser. If a randomly selected category turns out to perform relatively well, then techniques such as audience segment expansion, audience segment rotation, and audience segment narrowing, and audience segment subset ranking may be used to further refine the randomly selected category.

In particular embodiments, an audience segment expansion may be included in an updated audience segment in any of various ways. For instance, an audience segment may include a collection of individual or combined categories (e.g., individual categories A and B and combined category (C AND D) separated by Boolean OR variables, such as “Segment 1=A OR B OR (C AND D)”. In this case, a new category E may be joined with the other base categories if suitable. For instance, the updated Segment 2 may be configured as “Segment 2=A OR B OR (C AND D) OR E”. Alternately, or additionally, an audience segment expansion may be added to expand a combined category, for instance if the audience segment expansion is based on a portion of the combined category. In this case, the updated Segment 2 may be configured as “Segment 2=A OR B OR (C AND (D OR E))”.

In particular embodiments, audience segment expansion may be combined with other forms of audience segment alteration. For example, subsets of an audience segment may be rank ordered based on performance as discussed with respect to FIG. 2. Then, the relatively high ranking subsets may be selected for expansion as discussed with respect to FIG. 4.

FIG. 5 illustrates an example of an audience segment restriction method 500, performed in accordance with one or more embodiments. The method 500 may be performed in order to build a less inclusive audience segment than the initial audience segment. For instance, if it is determined that the number of audience members identified by the initial audience segment is comparatively small but that the performance of the initial audience segment could be improved, then the initial audience segment may be restricted in an effort to identify a higher performing audience segment.

At 502, a request to restrict an audience segment is received. In some embodiments, the request may be generated as part of a configuration process for an advertising campaign, as discussed with respect to FIG. 1. For instance, the request may be generated when a determination is made to update an audience segment, as discussed with respect to operation 110 shown in FIG. 1.

At 504, an initial audience segment is identified. As discussed with respect to operation 104 shown in FIG. 1, the initial audience segment may be a set of parameters identifying individuals who may be identified for advertising opportunity bid placement by an advertising system. The initial audience segment may be any audience segment associated with the advertising campaign for which performance metric information is available. For instance, the initial audience segment may be any audience segment that is associated for which bids associated with the advertising campaign have previously been placed.

At 506, a plurality of subsets of the initial audience segment is identified. In some embodiments, the operation 506 may be substantially similar to the operation 206 discussed with respect to FIG. 2. Subsets may be identified based on various considerations such as the data sources available from data service providers, the amount of data available for a potential audience segment subset, the type of advertising campaign associated with the performance data being analyzed, and/or parameters specified by a user such as an advertiser or system administrator.

At 508, one or more audience segment restrictions are identified for the identified subsets. Various types of audience segment restrictions may be determined. In some implementations, an audience segment restriction may be determined by restricting the audience segment subsets in the initial audience segment by narrowing a range, by narrowing within a taxonomy or hierarchy, or by any other technique for selecting a more narrow set of categories for inclusion in the audience segment.

In some implementations, an audience segment restriction may be determined by restricting a range. For example, an initial audience segment or initial audience segment portion may target individuals with an estimated yearly income of between $35,000-$75,000. Then, an audience segment restriction may target individuals with an estimated yearly income of between $40,000-$50,000. As another example, an initial audience segment or initial audience segment portion may target individuals aged 20-40. In this case, an audience segment restriction may target individuals aged 24-36.

In some implementations, an audience segment restriction may be determined by narrowing a geographic region. For example, an initial audience segment or initial audience segment portion may target individuals within a particular state or geographic region. In this case, an audience segment restriction may target individuals within particular cities or counties within the geographic region identified in the initial audience segment. As another example, an initial audience segment or segment portion may target “Travel Intent: Florida”. In this case, an audience segment restriction may target “Travel Intent: Miami”.

In some implementations, an audience segment restriction may be determined by narrowing by hierarchy or taxonomy name. For example, example, an initial audience segment or initial audience segment portion may target both males and females. In this case, an audience segment restriction may be limited to only males or only females. As another example, an initial audience segment or segment portion may target “In-Market auto buyers”. In this case, an audience segment restriction may target “In-Market Honda buyers”, “In-Market Honda Civic buyers”, or “In-Market compact auto buyers.”

In particular embodiments, an audience segment restriction may be included in an updated audience segment in any of various ways. For instance, an audience segment may include a collection of individual or combined categories (e.g., individual categories A and B and combined category (C AND D) separated by Boolean OR variables, such as “Segment 1=A OR B OR (C AND D)”.

In this case, a new category E that is more restrictive than the previously used category A may replace the category A. For instance, the updated Segment 2 may be configured as “Segment 2=E OR B OR (C AND D)”. Alternately, or additionally, an audience segment restriction may be added to restrict a combined category, for instance if the audience segment restriction is based on a portion of the combined category. In this case, the updated Segment 2 may be configured as “Segment 2=A OR B OR (C ANDD AND E)”.

In particular embodiments, audience segment restriction may be combined with other forms of audience segment alteration. For example, subsets of an audience segment may be rank ordered based on performance as discussed with respect to FIG. 2. Then, the relatively low performing subsets may be selected for restriction as discussed with respect to FIG. 5.

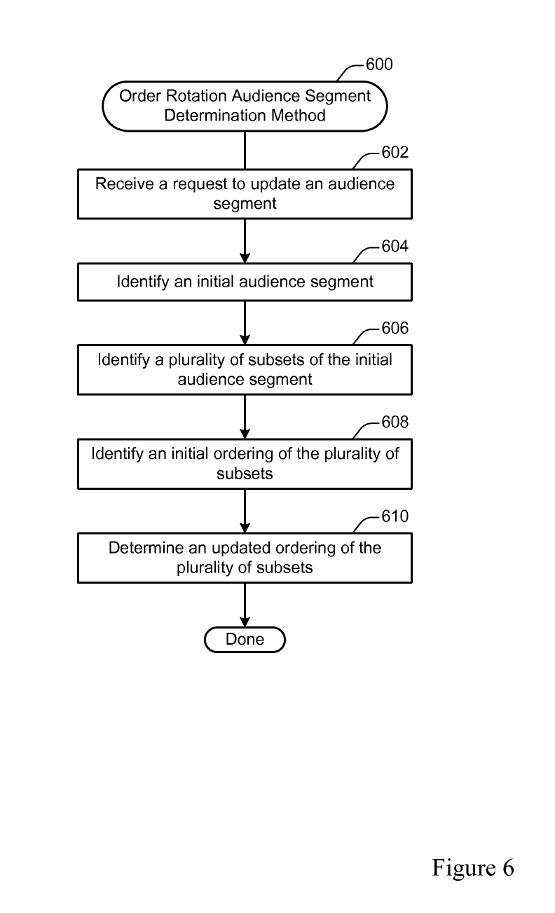

FIG. 6 illustrates an example of an order rotation audience segment determination method 600, performed in accordance with one or more embodiments. The method 600 may be performed in order to adjust the priority assigned to categories within an audience segment. By adjusting the priority in this way, relatively higher performing categories may potentially be prioritized over relatively lower performing categories. In some instances, this type of prioritization may provide increased quality and/or decreased data cost for bids placed based on the prioritized audience segment.

At 602, a request to update an audience segment is received. In some embodiments, the request may be generated as part of a configuration process for an advertising campaign, as discussed with respect to FIG. 1. For instance, the request may be generated when a determination is made to update an audience segment, as discussed with respect to operation 110 shown in FIG. 1.

At 604, an initial audience segment is identified. As discussed with respect to operation 104 shown in FIG. 1, the initial audience segment may be a set of parameters identifying individuals who may be identified for advertising opportunity bid placement by an advertising system. The initial audience segment may be any audience segment associated with the advertising campaign for which performance metric information is available. For instance, the initial audience segment may be any audience segment that is associated for which bids associated with the advertising campaign have previously been placed.

At 606, a plurality of subsets of the initial audience segment is identified. In some embodiments, the operation 606 may be substantially similar to the operation 206 discussed with respect to FIG. 2. Subsets may be identified based on various considerations such as the data sources available from data service providers, the amount of data available for a potential audience segment subset, the type of advertising campaign associated with the performance data being analyzed, and/or parameters specified by a user such as an advertiser or system administrator. For instance, the subset may be any data category or data source discussed with respect to the data hierarchy shown in FIG. 2. In particular embodiments, if a particular subset has a limited data source, the particular subset may be left out of the identification.

At 608, an initial ordering of the plurality of subsets is determined. According to various embodiments, the initial ordering may be determined by the prioritization of different content categories within the initial audience segment. Audience segment categories may be ordered in various ways. For instance, an initial audience segment may be prioritized such that categories listed earlier have higher priority than categories listed later. In this case, the categories in the audience segment “Segment 1=(A AND B) OR C OR (D AND E)” would be prioritized such that advertising opportunity bid requests that meet the criteria of (A AND B) would receive the highest priority. The next higher priority would correspond with advertising opportunity bid requests that meet the criterion of C. The lowest priority would correspond with advertising opportunity bid requests that meet the criteria of (D AND E).

At 610, an updated ordering of the plurality of subsets is determined. According to various embodiments, the updated ordering may be determined in any of various ways. For example, the ordering may be altered randomly. As another example, the ordering may be altered in an organized fashion so that successive reorderings may be used to compare the performance of different orderings of audience segment categories.

In many instances, various possible reorderings of an audience segment are possible. For instance, if “Segment 1=(A AND B) OR C OR (D AND E)”, then possible reoderings may include, but are not limited to: “Segment 2=C OR (A AND B) OR (D AND E)”, “Segment 3=(D AND E) OR (A AND B) OR C”, and “Segment 4=(A AND B) OR (D AND E) OR C”.

In particular embodiments, ordering may be combined with other types of segment updating techniques such as rank ordering. For instance, the categories within an audience segment may be rank ordered and then prioritized in order of performance. In this way, advertising opportunity bid requests associated with relatively higher performing categories may be selected first. Then, advertising opportunity bid requests associated with relatively lower performing categories may be selected if, for instance, an insufficient number of bid requests associated with the relatively higher performing categories are available to meet a budget constraint.

In some instances, reordering may provide improved performance by reducing costs rather than increasing a number of actions or clicks. For instance, suppose that the initial audience segment is configured such that “Segment 1=A OR B”. Also suppose that the categories A and B have considerable overlap but that category A is more expensive than category B. In this case, data costs for bid placement may be attributed to category A. However, if the initial segment is rotated to produce the updated segment “Segment 2=B OR A”, then quality may be maintained while reducing data costs since most data costs for bid placement may instead be attributed to the lower cost category B.

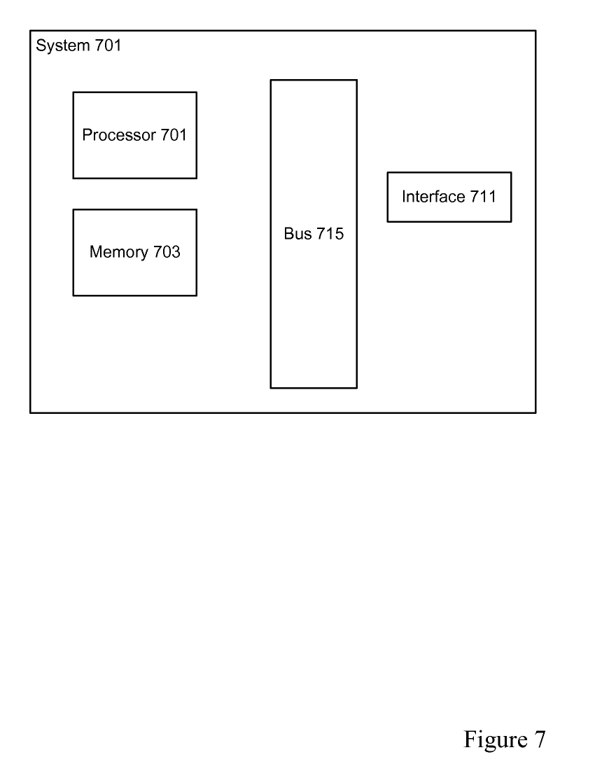

FIG. 7 illustrates one example of a server. According to particular embodiments, a system 700 suitable for implementing particular embodiments of the present invention includes a processor 701, a memory 703, an interface 711, and a bus 715 (e.g., a PCI bus or other interconnection fabric) and operates as a counter node, aggregator node, calling service, zookeeper, or any other device or service described herein. Various specially configured devices can also be used in place of a processor 701 or in addition to processor 701. The interface 711 is typically configured to send and receive data packets over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. Although a particular server is described, it should be recognized that a variety of alternative configurations are possible.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
identifying a performance metric for an initial audience segment via a computer processor at a demand-side platform, the initial audience segment designating a first criterion used to select a first plurality of advertising opportunity bid requests for bid placement;
determining an updated audience segment based on the performance metric via the computer processor, the updated audience segment designating a second criterion used to select a second plurality of advertising opportunity bid requests for bid placement, the updated audience segment representing a subset of the initial audience segment;
selecting, by the processor, the updated audience segment for bid placement; and
transmitting, via a communications interface at the demand-side platform, a message to place a bid for an advertising campaign on an advertising opportunity bid request, the advertising opportunity bid request being associated with an advertising audience member, the advertising audience member matching the second criterion.

2. The method recited in claim 1, wherein determining the updated audience segment comprises:
determining a respective performance metric for each of a plurality of subsets of the initial audience segment.

3. The method recited in claim 2, wherein determining the updated audience segment further comprises:
designating a first one of the subsets for inclusion in the updated audience segment via the computer processor when it is determined that the first one of the subsets is associated with a respective performance metric that exceeds a designated performance metric threshold value.

4. The method recited in claim 1, wherein determining the updated audience segment comprises:
identifying a first ordering of a plurality of subsets of the initial audience segment, and
determining a second ordering of the plurality of subsets for inclusion in the updated audience segment, the second ordering being different than the first ordering, each of the first and second orderings prioritizing advertising opportunity bid requests that correspond to earlier-ordered subsets.

5. The method recited in claim 4, wherein each of the first and second orderings designates a respective order in which the plurality of subsets are joined by a Boolean OR operator.

6. The method recited in claim 1, wherein determining the updated audience segment comprises:
determining a second audience segment portion for inclusion in the updated audience segment based on a first audience segment portion included in the initial audience segment, the second audience segment portion including the first audience segment portion, the second audience segment portion being broader than the first audience segment portion.

7. The method recited in claim 6,
wherein the second criterion includes the first criterion and a third criterion joined by a Boolean OR operator.

8. The method recited in claim 1, wherein determining the updated audience segment comprises:
determining a second audience segment portion for inclusion in the updated audience segment based on a first audience segment portion included in the initial audience segment, the first audience segment portion including the second audience segment portion, the first audience segment portion being broader than the second audience segment portion.

9. The method recited in claim 8,
wherein the first audience segment portion includes a first criterion for selecting advertising opportunity bid requests for bid placement,
wherein the second audience segment portion includes the first criterion and a second criterion for selecting advertising opportunity bid requests for bid placement, and
wherein the first and second criteria are joined by a Boolean AND operator.

10. The method recited in claim 1, wherein the performance metric comprises a metric selected from the group consisting of: cost-per-click (CPC), cost-per-action (CPA), click-through-rate (CTR), and action-rate (AR).

11. The method recited in claim 1, wherein identifying a performance metric for the initial audience segment comprises:
identifying a first subset of the plurality of advertising opportunity bid requests selected for bid placement that resulted in placed advertisements,
determining a respective outcome measure for each of the bids within the first subset, and
aggregating the respective outcome measures.

12. The method recited in claim 1, wherein each of the first and second pluralities of advertising opportunity bid requests is received from a real-time bid exchange operable to facilitate the programmatic buying and selling of advertising impressions via a network.

13. The method recited in claim 1, wherein each of the initial audience segment and the updated audience segment designate a respective one or more data sources, each data source identifying a respective group of individuals having one or more characteristics in common.

14. A demand-side platform system comprising:
a memory system operable to store a performance metric for an initial audience segment, the initial audience segment designating a first criteria used to select a first plurality of advertising opportunity bid requests for bid placement;
a processor operable to determine an updated audience segment based on the performance metric via a computer processor, the updated audience segment designating a second criterion used to select a second plurality of advertising opportunity bid requests for bid placement, and select the updated audience segment for bid placement, the updated audience segment representing a subset of the initial audience segment; and
a communications interface operable to transmit a message to place a bid for an advertising campaign on an advertising opportunity bid request, the advertising opportunity bid request being associated with an advertising audience member, the advertising audience member matching the second criterion.

15. The system recited in claim 14, wherein determining the updated audience segment comprises determining a respective performance metric for each of a plurality of subsets of the initial audience segment and designating a first one of the subsets for inclusion in the updated audience segment when it is determined that the first one of the subsets is associated with a respective performance metric that exceeds a designated performance metric threshold value.

16. The system recited in claim 14, wherein determining the updated audience segment comprises identifying a first ordering of a plurality of subsets of the initial audience segment and determining a second ordering of the plurality of subsets for inclusion in the updated audience segment, the second ordering being different than the first ordering, each of the first and second orderings prioritizing advertising opportunity bid requests that correspond to earlier-ordered subsets, each of the first and second orderings designating a respective order in which the plurality of subsets are joined by a Boolean OR operator.

17. The system recited in claim 14, wherein determining the updated audience segment comprises determining a second audience segment portion for inclusion in the updated audience segment based on a first audience segment portion included in the initial audience segment, the second audience segment portion including the first audience segment portion, the second audience segment portion being broader than the first audience segment portion.

18. The system recited in claim 14, wherein determining the updated audience segment comprises determining a second audience segment portion for inclusion in the updated audience segment based on a first audience segment portion included in the initial audience segment, the first audience segment portion including the second audience segment portion, the first audience segment portion being broader than the second audience segment portion.

19. The system recited in claim 14, wherein the performance metric comprises a metric selected from the group consisting of: cost-per-click (CPC), cost-per-action (CPA), click-through-rate (CTR), and action-rate (AR).

20. One or more non-transitory computer readable media having instructions stored thereon for performing a method, the method comprising:
identifying a performance metric for an initial audience segment via a computer processor at a demand-side platform, the initial audience segment designating a first criteria used to select a first plurality of advertising opportunity bid requests for bid placement;
determining an updated audience segment based on the performance metric via the computer processor, the updated audience segment designating a second criterion used to select a second plurality of advertising opportunity bid requests for bid placement, the updated audience segment representing a subset of the initial audience segment;
selecting, by the processor, the updated audience segment for bid placement; and
transmitting, via a communications interface at the demand-side platform, a message to place a bid for an advertising campaign on an advertising opportunity bid request, the advertising opportunity bid request being associated with an advertising audience member, the advertising audience member matching the second criterion.
